(19) United States
(12) Patent Application Publication
(10) Pub. No.: US 2010/0084200 A1
(43) Pub. Date: Apr. 8, 2010

(54) FOOD PRODUCT PRICING SCALE WITH AUTOMATED MULTI-LANGUAGE INTERFACE

(76) Inventors: Santos J. Juan-Castellanos, Springfield, OH (US); Joe H. Crew, Springfield, OH (US)

Correspondence Address: THOMPSON HINE LLP;Intellectual Property Group, P.O Box 8801, DAYTON, OH, 45401-8801, US

(21) Appl. No.: 12/512,681

(22) Filed: Jul. 30, 2009

Related U.S. Application Data
(60) Provisional application No. 61/102,988, filed on Oct. 6, 2008.

(51) Int. Cl. G01G 19/40

(52) U.S. Cl. 177/25.15

(57) ABSTRACT

A scale, such as a food product scale in a perishables department of a store, identifies an operator via an RF detection system, or other operator identification system, and displays information on the scale user interface in a preferred language for the identified operator.

### CROSS-REFERENCES

This application claims the benefit of U.S. provisional application Ser. No. 61/102,988, filed Oct. 6, 2008, the entirety of which is incorporated herein by reference.

### TECHNICAL FIELD

The present invention relates generally to scales of the type commonly used in groceries and supermarkets for weighing random weight items in the nature of food products such as meats and produce and, more particularly, to a random weight item or other store production scale including an automated function to interface with the operator in the operator's preferred language.

### BACKGROUND

Often a food department will employ service personnel that represent different preferred languages to work together operating the same food product scale or set of scales. A scale user interface which is only available in a single language is a hindrance to those operators who might speak, write, or read a different language commonly used in the area or country.

Accordingly, it would be desirable and advantageous to have a scale and scale system that is adapted to automatically display the user interface in the operator's preferred language.

### SUMMARY

A scale system is provided capable of automatically changing its user interface presentation to match a scale operator's preferred language, without any operator interaction with the scale other than the physical proximity, by detecting and identifying an RFID device carried by the operator. The scale system associates the RFID device with a preferred language and changes the user interface to reflect that preferred language.

In one aspect, in a store including a department having a counter with a customer side and a service person side, a scale system includes a weighing station for receiving items to be weighed and having an associated mechanism for producing weight indicative signals when items are placed on the weighing station, a pricing control operable to establish a price for a weighed item based in part upon a weight indicative signal produced for that item, and an RF detection system outputting an RF detection field in proximity to the scale for detecting the presence of RF identification units within the detection field. The RF detection field defines a limited detection range. The scale is adapted to identify a single one of the RF identification units as being associated with a service person likely to next use the scale and display the user interface in the service person's preferred language, enabling multiple service persons with corresponding RF identification units to repeatedly move back and forth past the scale without causing a language shift until such an identification is made.

In another aspect, the language switch occurs as part of an automatic login process necessary to access the scale. When the scale system identifies a service person likely to next use the scale, an automatic login takes place using the record associated with that service person. That record includes an entry for preferred language, and upon automatic login the user interface changes to display the identified language.

### BRIEF DESCRIPTION OF DRAWINGS

FIG. 1 is a perspective view of an exemplary scale system located within a perishables department of a store.

FIG. 2 is a schematic illustration of a scale and RF identification unit.

FIG. 3 is a schematic flow process for scale operation.

### DETAILED DESCRIPTION

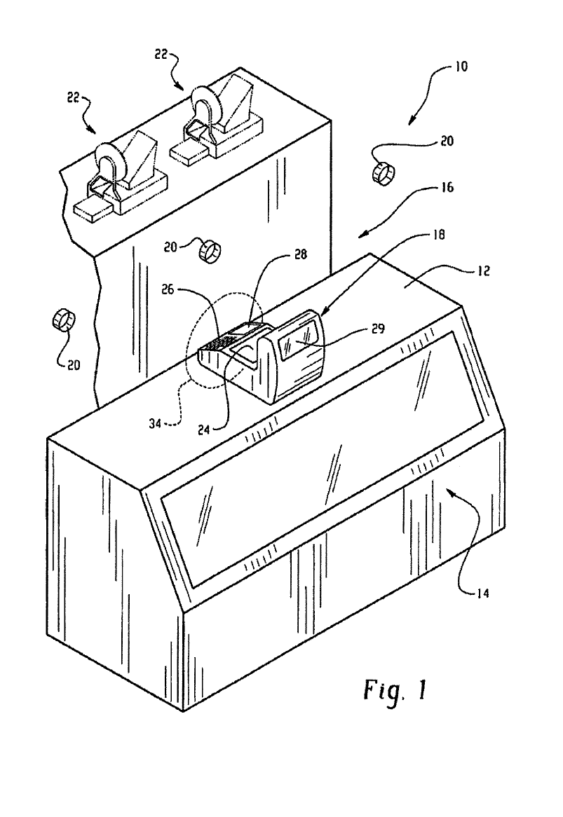

Referring to FIG. 1 an exemplary scale 18 is shown including a weigh station 24 and an operator display 28. Weigh station 24 may take the form of a platter-type member supported in relationship to a load cell (internal of the scale housing) that produces a weight indicative signal when a food item is placed on the weigh station 24 for weighing. Illustrated display 28 may take the form of an LCD-type display, but other technologies could be used. The display 28 may be a touch screen-type display that also functions as a user input device by displaying image buttons/icons that can be triggered or selected by an operator. The buttons/icons allow for user selection of an item to be weighed from a menu or group of items presented to the user by display. In one variation, the group may be a numeric keypad allowing manual entry of product numbers. In another variation, the group may be images of specific products that might be weighed by the scale. A separate operator input device could also be provided, for example, in the form of manually activated keys/buttons 26 located alongside the display as shown. A side portion of the scale housing holds a label printer and associated supply of labels, which are dispensed through a label slot in the housing. Although display screen is shown incorporated into the housing of the scale, the display could take the form of a marquee-type display located on a support extending upward from the scale housing. In some implementations (e.g., a scale weigh and label system associated with a package wrapping machine for prepack), the display need not be attached to the scale/printer via a support but could be a separately housed console that is logically attached to the scale/printer.

Referring to FIG. 1, a scale system 10 is located in a store perishables department (such as a deli department, meat and fish department or baked goods department) having a counter 12 with a customer side 14 and a service person side 16. The scale system includes a scale 18 located atop the counter 12 and adapted for weighing and pricing random weight items, and multiple RF identification units 20 separate from the scale. In the illustrated embodiment a single scale 18 is shown, but many departments will include multiple scales. Likewise, while a single counter is shown, many departments will include multiple counters arranged adjacent each other to effectively form one continuous counter. An alternative embodiment may be a hanging scale located above the counter 12. The RF identification units may take the form of wrist-band type units, or other structures, that are worn proximate to the hands of the service persons (not shown). The scale is adapted for enabling multiple service persons to utilize the scale. Typically such multiple service persons move around on the service person side 16 of the counter 12, interacting with customers, slicing food products at slicers 22 and then using the scale or scales 18 to weigh and label the sliced food products.

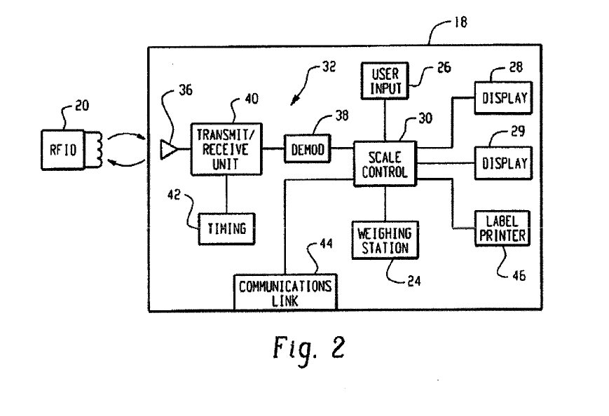

The scale 18 includes a weighing station 24 for receiving items to be weighed and having an associated mechanism, such as a load cell located internal of the scale housing, for producing weight indicative signals when items are placed on the weighing station 24. The scale 18 also includes an input device 26, which in the illustrated embodiment takes the form of a plurality of input keys or buttons located alongside an operator display screen 28. Also shown is a customer display screen 29. The scale includes a controller 30 (FIG. 2) operatively connected to the input device 26 and the mechanism. The controller is operable to establish a price for a weighed item based in part upon a weight indicative signal produced for that item. In this regard, the scale controller may include its own database of product price information (e.g., price per pound) that it retrieves when the service person inputs a PLU (price look-up) number or other product code of an item being weighed. Alternatively, the scale 18 may include a communication link 44 (FIG. 2) to a remote computer system having the database of product price information.

The scale 18 includes an RF detection system 32 (FIG. 2) outputting an RF detection field 34 (FIG. 1) in proximity to the input device 26 for detecting the presence of RF identification units 20 near the input device 26. The RF detection field 34 defines a limited detection range. In one example the detection range may be no more than twelve inches from the input device 26 (such as in the range of six to twelve inches). In another example the detection range may be no more than eighteen inches from the input device 26. The limited detection range enables multiple service persons to repeatedly move back and forth past the scale 18 without having the RF detection system detect their respective RF identification units 20 until a given service person takes an action indicative of an intent to use the scale 18 by moving the hand having the associated RF identification unit 20 toward the input device 26 and within the limited detection range of the RF detection field 34.

In the system 10, the RF identification units may be passive, read only RF identification units 20 that are powered by the RF detection field 34 output by the scale 18, typically generated at a frequency between 100 kHz and 450 kHz. It is recognized that wide variations in frequency are possible depending upon the nature of the RF detection unit and the desired detection range, with higher frequencies typically being used to enable grater detection ranges. In one embodiment, the RF detection field 34 is generated at 125 kHz. In other words, each RF identification unit includes a coil across which an electrical signal is induced or otherwise developed when it is positioned in the RF detection field. That electrical signal is used to power the unit, causing it to become active when it is within the RF detection field 34. The unit 20 uses an impedance modulation technique to transfer information back to the transmit/receive coil 36 (FIG. 2) of the scale. The information transmitted might typically be a unit specific code or number stored in memory of the unit 20. Once the RF identification unit 20 is placed in the RF detection field 34 and powered up as a result of the same, it begins transmitting its unique code via impedance modulation which dampens the RF signal of the detection field enabling a demodulator 38 (FIG. 2) to detect the code.

Referring now to FIG. 2, in one embodiment the RF detection system 32 includes transmit/receive unit 40 associated with transmit/receive coil 36, a timing circuit 42 associated with the unit 40 and a demodulator 38 connected to unit 40. The demodulator identifies RF identification unit codes and sends them to the scale control 30.

When an operator approaches a scale equipped with an RFID receiver and the operator carries a compatible RFID tag, the scale will become aware of the presence of this RFID tag in its proximity field as the tag transfers its encoded identifier to the receiver.

The scale then uses the received identifier to attempt to retrieve an operator record from its database so as to identify a preferred language. If it fails to retrieve a record, then it would create a new operator record with default values (like preferred language set to the scale's primary language) and the encoded identifier, which becomes the retrieved record. This operator record could have been created in the scale's database either through user interaction with the display 28 or other user interface, by processing a data stream coming from a data file or communication channel (not shown), generated automatically if not present (in the default manner mentioned above), or by other suitable means.

When the operator interacts with the scale's user interface, information is presented to the operator in the operator's preferred language (as reflected by the record associated with the operators unique RFID). The scale will present all text, graphics containing text, menus, and other language-specific visual elements of the user interface in the preferred language.

By the mere proximity of the operator to the scale (which is required for the operator to use the sale) the scale application is capable of deciding whether to automatically change the language in which the user interface is presented in order to match the operator's preferred language. This will increase productivity as operators will no longer have to struggle with an unfamiliar language displayed on the screen or have other employees translate text for them. Additionally, it will ensure operators update fields and data correctly on the screen promoting an accurate printing of the label that is placed on the package.

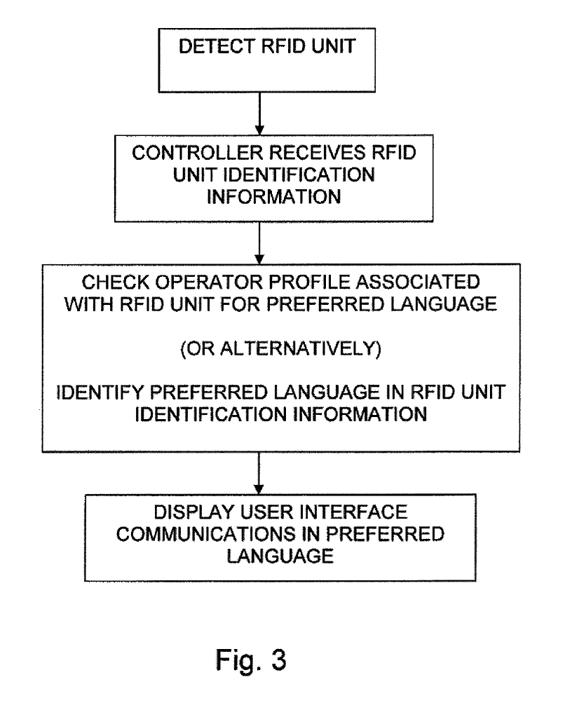

In one embodiment, this operation occurs as part of an automatic login process. U.S. Pat. No. 7,041,915, which is hereby incorporated by reference, describes an automatic login process by which the proximity of a remote tag such as an RFID tag can automatically identify an employee and provide that employee access to the scale without requiring a manual login. The system automatically performs an operator login operation enabling the service person wearing a compatible RF identification unit to use the scale for an item weigh and label print transaction. As part of this automatic identification process, a preferred language for the employee is also automatically identified, and the scale responds by changing the user interface to the identified language (e.g., per FIG. 3).

The automatic login could enable other scale functions as well. As a general proposition an automatic login operation enables some scale function not enabled prior to the login. It is contemplated that the number and type of functions enabled could be dependent upon the RFID code that results in the login. In other words, different levels of scale functionality could be enabled according to the service person being logged in, where each service person is identified by a unique RFID code. The scale may be considered to be in an idle mode, awaiting login, during non-use periods. After the automatic login the scale is placed in an operating mode. In one example, during the idle mode the scale may be adapted to prevent labels from being printed, while in the operating mode labels can be printed for weighed items.

In another embodiment, the preferred language may be directly identified by the RFID tag used. For instance, the ID tags may come in a small number of groups, each group of tags associated with a given preferred language. In this embodiment, each service person would choose an ID tag corresponding to that person's preferred language. This has the advantage of potentially requiring a smaller number of tags, as a different tag is not needed for each individual. Instead, a service person can simply select a tag representing the appropriate language when performing services that are likely to involve the use of the scale system and then return the tag to the store supply.

The identification operation may therefore be associated with an automatic login to enable the use of scale features, may be associated with an individual user profile that includes information on the user's preferred language, or may simply identify a certain RFID code or range of codes directly with a preferred language. Whatever the details associated with the identification operation, the result is that an RFID identification operation triggers an automatic shift in the user interface to display in the preferred language.

In an alternative embodiment of the scale system, rather than performing the operation as soon as an acceptable RF identification unit is detected within the RF detection field 34, the scale could be configured to only perform the operation after an acceptable RF identification unit is detected within the RF detection field for at least a minimum time duration. In one example of such an embodiment the RF identification units may take the form of items worn around the neck as by a chain. In another example the RF identification units may take the form of clip on tags that can be clipped to a shirt collar or shirt pocket. In still another example the RF identification units may simply be held in a shirt, coat or pants pocket. Depending upon the intended location of the RF identification units on the service persons, the range of the RF detection field can be adjusted accordingly. For example, where the RF identification units are worn on a chain around the neck, clipped to a collar or shirt pocket or are simply held in a shirt pocket or coat pocket, the range of the detection field may be slightly greater than arms length, such as in the range of about 1.5 feet to 3 feet, from the scale so that the units are located within the detection field when the service person stands in front of the scale to weigh an item.

Regardless of whether the identification operation is performed immediately upon detection of an acceptable RF identification unit within the RF detection field or only after an acceptable RF identification unit is detected within the RF detection field for a minimum time duration, both embodiments provide a scale that is adapted to only perform the operation in association with an RF identification unit associated with a service person likely to next use the scale. The arrangements therefore avoid triggering on service persons having RF identification units that are not identified as likely to next use the scale, enabling multiple service persons to repeatedly move back and forth past the scale without the operation occurring until such persons are identified as likely to next use the scale. However, it is recognized that occasionally the identification operation may be performed for a service person that does not actually intend to use the scale at that time. Nevertheless, in the various embodiments the RF detection system and controller are adapted to identify, from among a plurality of RF identification units in a vicinity of the scale, a particular one of the RF identification units that meets certain criteria indicating a likelihood (not necessarily a guarantee) of scale use and to perform an operation for the particular RF identification unit. In one case the criteria is simple detection of the RF identification unit within a limited range RF detection field, while in another case the criteria is detection of the RF identification unit within an RF detection field for a minimum time duration.

In the case of RFIDs uniquely keyed to individual profiles, once an automatic login operation is performed, the scale can track scale activities performed during that login and associate such tracked activities with the RF identification unit that caused the login. For example, the items weighed and labels printed for each RF identification unit can be tracked. If the scale is configured to communicate with the source of the operator profile, the scale may also be able to modify the profile based on the operator's activity. For example, if the operator chooses to manually change the display language through the user interface, the scale could cause the user profile's preferred language to change to the language selected by the operator. This would prevent a service person whose preferred language has not been properly entered into the user database from having to change the display to the preferred language each time; instead the scale system would remember and replicate the operator's action by automatically shifting the language for that operator thereafter.

The scale may also be adapted to perform an automatic logout operation if a service person does not utilize the scale within a certain time period after the login. Further, an automatic logout may also be performed as soon as a given scale operation is completed, such as an item weigh and label print operation. The scale may automatically return to displaying in accordance with the default language in response to a logout, or alternatively, may continue to display in accordance with the last identified preferred language. In one embodiment, once an automatic login operation is performed, the scale control 30 may ignore other RF identification units detected within the RF detection field until a logout takes place, preventing overlapping login operations. In another embodiment, the scale control 30 may have a feedback connection to the RF detection system, disabling the detection system (e.g., stopping output of the RF detection field) while a person is logged into the scale.

Although the invention has been described and illustrated in detail it is to be clearly understood that the same is intended by way of illustration and example only and is not intended to be taken by way of limitation. For example, while the use of passive type RF identification units is described, active, self powered RF identification units could be used in some cases. It is recognized that numerous other variations exist, including both narrowing and broadening variations of the appended claims.

What is claimed is:

1. A multi-language food product scale system, including:
a weighing station for weighing food items;
a user interface including a display screen;
an RF detection system for outputting an RF field for detecting the presence of an RFID unit within the RF field;
a scale controller connected to control the user interface and connected to receive information from the RF detection system and the weighing station, the scale controller configured to operate such that:
upon receiving RFID unit identification information from the RF detection system, the scale controller utilizes the RFID unit identification information to identify a display language to be used on the display screen and effects operation of the display screen to display information in the identified language.

2. The scale system of claim 1 wherein the scale includes an associated operator profile database, the scale controller identifies the display language by using the RFID unit identification information to access a specific operator profile and the display language is contained in the operator profile.

3. The scale system of claim 1 wherein the scale controller is configured to operate such that:
in response to receiving the RFID unit identification information, the scale controller attempts to identify an operator profile associated with the RFID unit identification information and if no such operator profile is found, the scale controller creates a new operator profile associated with the RFID unit identification information, the new operator profile having a preferred language element set to a default language.

4. The scale system of claim 1, wherein the scale controller is configured to operate such that:
a language preference interface screen is displayed on the display screen enabling an operator using the user interface to select a language to be displayed that is a different language than the preferred language element of the operator profile, and the scale controller responsively changes the preferred language element of the operator profile to the language selected by the operator.

5. The scale system of claim 1 wherein the RFID unit identification information contains a direct indicator of the display language.

6. A method for language customization on a scale system, comprising:
(a) providing a scale system including
a weighing station,
a scale controller,
a user interface capable of displaying information in at least two languages, and
an operator identification mechanism;
(b) identifying a scale operator via the operator identification mechanism;
(c) based upon the identification made in step (b), identifying a preferred language for the scale operator;
(d) the user interface displaying information in the identified preferred language.

7. The method of claim 6 wherein, the operator identification system includes an RF detection system, the RF detection system sensing an RFID unit and communicating RFID unit identification information to the scale controller;
the scale controller, in response to receiving the RFID unit identification information, accessing a database to identify the preferred language for the scale operator.

8. The method of claim 7, wherein the database is a database of operator profiles, each operator profile including a preferred language element.

9. The method of claim 9 wherein,
the scale controller, in response to receiving the RFID unit identification information, accesses the database and either matches the RFID unit identification information to a profile in the database or finds no match;
if no match is found, the scale controller creates a new operator profile associated with the RFID unit identification information, the new profile preferred language set to a default language.

10. The method of claim 8, further comprising:
an operator using the user interface to select a language to be displayed that is a different language than the preferred language element of the operator profile; and
the scale controller automatically changing the preferred language element of the operator profile to the language selected by the operator.

11. A multi-language food product scale system, including
a weighing station;
a user interface including a display screen;
a scale controller connected to control the user interface and connected to receive information from the weighing station, the scale controller configured to operate such that:
a scale operator is identified;
a display language to be used for the identified operator is automatically identified from among at least two possible languages;
operation of the display screen is effected to display information in the identified display language.

12. The food product scale system of claim 11 wherein the scale includes an RF detection system that is used to identify an operator RFID unit in order to identify the scale operator.

13. The system of claim 11 wherein the food product scale system is part of a package wrapping device.
